(19) United States
(12) Patent Application Publication
(10) Pub. No.: US 2009/0116156 A1
(43) Pub. Date: May 7, 2009

(54) PORTABLE ELECTRONIC DEVICE

(75) Inventors: Takashi Yoshinaga, Tokyo (JP); Kenji Kataoka, Tokyo (JP); Michihito Ootsuki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/091,409

(22) PCT Filed: Sep. 12, 2006
(86) PCT No.: PCT/JP2006/318068

§ 371 Date: Jan. 2, 2009

(30) Foreign Application Priority Data
Oct. 27, 2005 (JP) 2005-313580

(51) Int. Cl. H02H 9/00

(52) U.S. Cl. 361/56

(57) ABSTRACT

In the portable electronic device of the present invention, charging electrodes exposed to the exterior of a casing are electrically connected to a pair of charging terminals mounted upright on the printed circuit board, and a charging terminal (negative electrode, or ground) that is one of the pair of charging terminals is connected to the ground of the printed circuit board. A high-frequency current suppression part is mounted in a series connection on the charging terminal (negative electrode, or ground). The high-frequency current suppression part is a ferrite core, ferrite beads, or another low resistance part. In such a configuration, a secondary electric discharge occurs via the externally exposed charging electrodes and the like when electrostatic discharge noise is applied from the exterior of the portable electronic device and when the ground current of the printed circuit board oscillates due to the discharge electric current that flows at this time, whereby circuit malfunctions are prevented.

### TECHNICAL FIELD

The present invention relates to a technology for preventing electronic circuit malfunctions brought about by electrostatic discharge, and particularly relates to a technology for preventing malfunctions in portable electronic devices provided with a charging terminal.

### BACKGROUND ART

In recent times, malfunctions brought about by external electromagnetic stress from electrostatic discharge noise and the like occur more readily at the lower operating voltages used in LSI (Large Scale Integration). Electrostatic discharge noise may even destroy an LSI in an electronic device.

An imaging device that prevents malfunctions and the destruction of a device in advance due to the effect of external noise and static electricity is disclosed in patent document 1. FIG. 6 is a block connection diagram showing the conventional imaging device described in patent document 1. A camera 101, in which a microcircuit unit (MCU) is mounted, is provided with connection terminals T1 through T8 in order to form a connection with an external electronic device 102 via a connecting cable 103, as shown in FIG. 6. Among the connection terminals, connection terminals T1 through T7, which are the signal ports, are provided with anti-noise filters FIL1 through FIL7. In this technology, an electric part provided with an action to suppress high-frequency electric currents that flow into the signal ports is added in order to avoid device malfunctions and destruction through the flow of electrostatic discharge currents via the connection terminals, T1 through T7, which are the signal port connection terminals, when a detachable external electronic device 102 is mounted in the camera 101 unit. In this case, it is necessary to select an electrical part that has a frequency characteristic that removes only the unnecessary high frequency noise current without compromising the transfer quality of the required high-frequency electric signal. This simultaneously necessitates making the ground port to have as low impedance as possible so that an electric potential difference does not occur in the ground that will act as the reference potential of the mutual electric signals between the external electronic device 102 and the camera 101 unit. For this reason, the same type of part is not added to the ground port. This is also apparent from the fact that the lower end connection terminal T8, which does not have an added filter part thought to be the ground port, is not directly connected to the ground, as seen in FIG. 6.

Although different in purpose from the above device, an example of ferrite material mounted as a high-frequency current suppression part on the ground port of a portable wireless device is disclosed in patent document 2. This prior art has a high-frequency current suppression part, which maintains high impedance in a high-frequency band, mounted on the connecting portion between a portable wireless device that can operate using an internally disposed rechargeable battery, and the charging unit of the portable wireless device. The portable wireless device is cut off from the charging unit in terms of high frequency. It can be envisioned in patent document 2 that performance degradation will occur in the portable wireless device unit when a high-frequency current suppression part is mounted in the portable wireless device unit, and it is a characteristic of the unit that the suppression part is mounted in the charging unit. This prior art prevents high-frequency current from flowing from the portable wireless device unit to the charging unit via the rechargeable battery, and reducing the antenna gain of the portable wireless device due a disruption of the ground current distribution.

In patent document 3, an electrically conductive member on which an antenna is mounted, and a connection terminal to which an external part is connected, are connected via high-impedance connection means that cuts off the conduction of high-frequency current in order to ensure that stable antenna characteristics can be obtained and that the effect exerted on antenna characteristics by electroconductive members other than the electroconductive members on which the antenna is installed can be reduced, in a portable wireless device having a detachable external part. In other words, in the prior art, high-impedance parts for cutting off conduction of high-frequency current are connected between electroconductive members that are disposed inside the portable wireless device and that contain signal transceiving circuits and the like, as well as a power terminal and earth terminal for connecting to an external charging unit. The mounting location is the main unit of the device. The high-frequency current that flows in the electroconductive member on which the antenna is mounted prevents drainage into electroconductive member disposed inside the external charging unit, and stabilizes antenna characteristics. However, high impedance of 120 π(Ω) or greater in the frequency used by the antenna is required in the high-impedance part in order to achieve this goal.

On the other hand, it is known that the occurrence of oscillations in the ground circuit due to electrostatic discharge current that flows into the ground circuit has a deleterious effect on CMOS circuits, as described in, e.g., non-patent document 1. In the document, a technique is described in which a series resistance or capacitance is added to the circuits as an effective way to deal with this problem.

Patent Document 1: Japanese Laid-Open Patent Application No. 09-275515

Patent Document 2: Japanese Laid-Open Patent Application No. 11-341126

Patent Document 3: Japanese Patent No. 3425073

Non-patent Document 1: Printed Circuit Board Design Techniques for EMC Compliance, by Mark I. Montrose. Translated as “Purinto Kairo no EMC Sekkei” by Hirokazu Deguchi and Masaaki Taue, Oomu-sha, Nov. 25, 1997, pp. 160-161.

### DISCLOSURE OF THE INVENTION

### Problems the Invention is Intended to Solve

However, the prior arts described above have problems such as those described below.

The prior art disclosed in patent document 1 has a problem in that the entry pathway for electrostatic noise is inherently limited to the signal ports. The reason for this is that it is difficult to add a filter part similar to a ground port because impedance in the high-frequency band must be kept low so that an electric potential difference will not be generated in the ground as described above. However, in portable electronic devices such as cellular phones, which run on an internal battery housed in the device, the entry pathway for electrostatic discharge noise is often a connector shell or another ground port rather than a signal port, and this cannot be handled by the art of patent document 1.

Provided hereunder is a general overview of a presumed entry of electrostatic discharge noise into the portable electronic device, the subsequent secondary electric discharge (a removal of electricity to the exterior of the device) that occurs, and the ground current of the printed circuit board that is a further source of LSI malfunctions. As described above, the entry pathway for noise is often a connector shell or another ground port. Electrostatic noise that enters the device from the exterior, or static electricity that is present in the portable electronic device due to friction of the device, may cause a secondary discharge from the ground to the exterior of the device. In such a case, the discharge pathway is a charging terminal or another ground port. In this instance, a discharge can occur on, e.g., a desk having a metal table top or the like, irrespective of whether the charging terminal is mounted inside the charging unit or not. The ground electric current of a printed circuit board produces oscillations due to the discharge electric current that flows at this time, and LSI malfunctions can occur due to the generation of an electric potential difference at the ground location.

The prior art disclosed in patent document 2 experiences a problem when an attempt is made to expand application to the electrostatic discharge noise described above. In other words, in the patent document, the high-frequency suppression part is mounted in the charging unit rather than in the device unit with the aim of preventing a decline in the performance of the device unit and isolating high frequencies between the device unit and the charging unit. Therefore, this method of dealing with static electricity does not function when the device is not mounted in the charging unit.

A purpose of the prior arts disclosed in patent documents 2 and 3 is the control of antenna characteristics, and a purpose is not the suppression of ground current from electrostatic discharge noise and the like. For this reason, characteristics that would be required in a high-frequency suppression part would inevitably be different, and both inventions entail the mounting of high-impedance parts.

The insertion of parts into a circuit as described in non-patent document 1 has a problem in that resistance parts or capacitance parts must be disposed in the circuits when the number of target circuits is considerable, and this leads to a larger device and simultaneously inhibits high-density mounting.

The present invention was contrived in view of the foregoing problems, and a purpose thereof is to provide a portable electronic device that can prevent situations in which a secondary electric discharge (diselectrification) occurs via externally exposed charging electrodes and the like, and circuit malfunctions are caused by oscillations brought about in the ground current of a printed circuit board by a discharge electric current that flows at this time, in cases in which electrostatic discharge noise is applied from the exterior to the portable electronic device.

### Means for Solving the Invention

The portable electronic device according to the present invention is characterized in having a printed circuit board, a casing for housing the printed circuit board, and an electrically conductive portion that is connected to a ground of the printed circuit board and in which a portion thereof is exposed on the exterior of the casing, wherein a high-frequency current suppression part having loss due to eddy current in relation to direct current is serially disposed between the electrically conductive portion and the ground, excluding the electrically conductive portion as a terminal used in data transmission.

When electrostatic discharge noise and the like is applied from the exterior to the portable electronic device, a secondary electric discharge occurs via charging electrodes and other electrically conductive parts that are exposed to the exterior of the casing, ground current of the device causes oscillations due to the discharge current that flows at this time, and an electric potential difference is generated depending on the ground location, whereby malfunctions are generated in the electronic circuits. Circuit malfunctions are prevented in the present invention by serially mounting a high-frequency current suppression part that suppresses a secondary discharge current between the printed circuit board ground and electrically conductive parts partially exposed to the casing exterior. It is preferred that a material that has an eddy current loss in a direct current be used as the high-frequency current suppression part, and it is further preferred that the high-frequency current suppression part be a low-resistance part.

In the present invention, the mounting location of the high-frequency current suppression part is at the portion where the secondary discharge current is discharged to the exterior. Also, countermeasure parts are concentrated in a single location, and an increase in the size of the device can be avoided in comparison with prior art in which it is general practice to mount high-frequency current suppression parts at the point of entrance of electrostatic discharge noise and the like.

The portable electronic device according to the present device is characterized in having a printed circuit board, a casing for housing the printed circuit board, and an electrically conductive portion that is connected to a ground of the printed circuit board and in which a portion thereof is exposed on the exterior of the casing, wherein a high-frequency current suppression part having a resistance value deemed equivalent to a case of connecting a metal wire having high electrical conductivity in relation to direct current is serially disposed between the electrically conductive portion and the ground, excluding the electrically conductive portion as a terminal used in data transmission.

The high-frequency current suppression part can be considered to be one having a resistance value deemed equivalent to a case of connecting a metal wire having high electrical conductivity in relation to direct current. Here, examples of metals having excellent conductivity include silver, copper, gold, aluminum, and other metals, and further include alloys, plating, and other like of these metals. Copper or aluminum is preferred from the standpoint of manufacturing costs. However, gold plating, which has a high resistance to corrosion, can be used in connection portions; and copper, a copper alloy, copper plating, or the like can be used in the wiring portions.

It is thus preferred that the high-frequency current suppression part be a material having a resistance value deemed equivalent to a case of connecting a metal wire having high electrical conductivity in relation to direct current. Specifically, sufficient effect can be achieved when the part is one having an impedance in which the real part Rₚ is 0.1 (Ω) or greater at high frequencies of 100 MHz or higher, and in which the real part Rₚ is Z or less, where Z is the magnitude of the characteristic impedance of the printed circuit board.

The imaginary part of the impedance of the high-frequency current suppression part is not required to be large. In other words, impedance that causes the loss of high-frequency current can be set so that the real part Rₚ is 0.1 (Ω) or greater at high frequencies of 100 MHz or higher, and the imaginary part Xₚ is (Z²−Rₚ²)^{0.5} or less, where Z is the magnitude of the characteristic impedance of the printed circuit board.

The electrically conductive portion exposed on the exterior of the casing can be, e.g., a charging terminal of a cellular phone or the like.

### EFFECTS OF THE INVENTION

In the present invention, a high-frequency current suppression part is disposed between the ground and an electrically conductive portion connected to the ground of the printed circuit board and a partially exposed on the exterior of the casing. Oscillations of the ground current of the printed circuit board that are induced when electrostatic discharge noise or the like is applied can thus be reduced, and printed circuit board malfunctions and destruction can be prevented. The original functionality is not affected in any way even if high-frequency current is suppressed by the present invention. This is because the sole consideration is to send direct current, or a low-frequency electric current parasitic to the direct current, to the charging terminal by way of the original function in cases in which the discharge pathway of a secondary discharge is a charging terminal of a portable communications terminal. Moreover, mounting space can be saved in comparison with conventional configurations because the high-frequency current suppression parts are concentrated and disposed in a single point.

### BRIEF DESCRIPTION OF THE DRAWINGS

FIG. 1 is a perspective view showing the basic structure of a charging terminal in a cellular phone terminal as a portable electronic device according to an embodiment of the present invention;

FIG. 2 is a perspective view showing the structure of a charging terminal provided with a part having a lead as a high-frequency current suppression part on the printed circuit board in the first modified example of an embodiment of the present invention;

FIG. 3 is a perspective view showing the structure of a charging terminal provided with a chip part as a high-frequency current suppression part on the printed circuit board in the second modified example of an embodiment of the present invention;

FIG. 4 is a graph showing results in which the frequency dependence of the maximum value of a discharge current is calculated in accordance with the presence or absence of a high-frequency current suppression part;

FIG. 5 is a schematic view describing a secondary discharge of an electrostatic discharge or an electrification charge; and

FIG. 6 is a block connection diagram showing the conventional imaging device disclosed in patent document 1.

### KEY

1: casing
2: printed circuit board
3: charging electrode
4a: charging terminal (positive electrode)
4b: charging terminal (negative electrode, or ground)
5: high-frequency current suppression part
6: wiring pattern
7: electrostatic discharge
8: printed circuit board ground
9: stray capacitance
10: grounding
11: secondary discharge conductor
12: secondary electrostatic discharge
13: electrification charge (positive terminal)
14: lead part
15: chip part
101: camera
102: electronic devices
103: connecting cable
MCU: microcircuit unit
T1 to T8: connection terminals
FIL1 to FIL7: filters

### BEST MODE FOR CARRYING OUT THE INVENTION

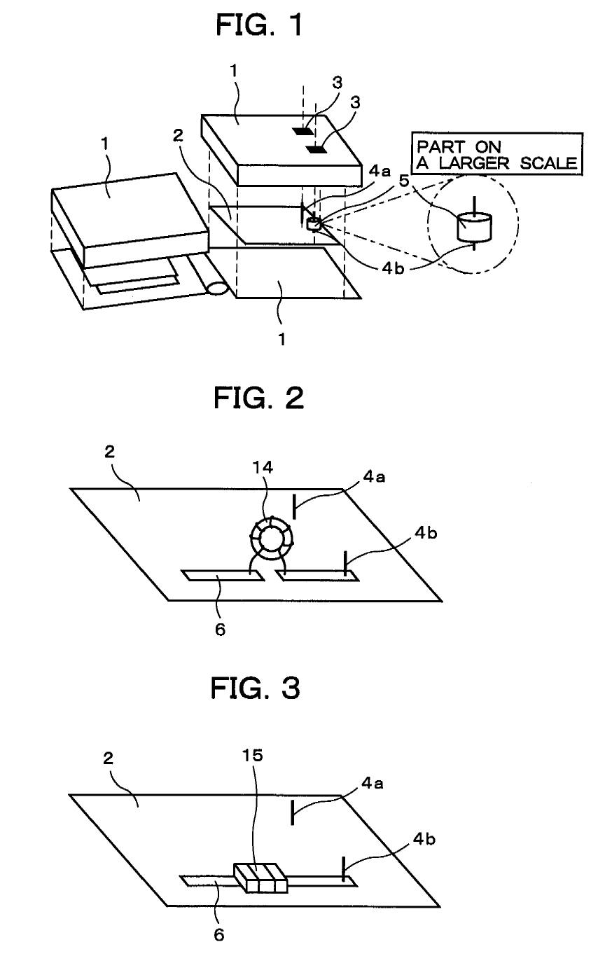

Embodiments of the present invention will be described in detail below with reference to the attached diagrams. FIG. 1 is a perspective view showing the basic structure of a charging terminal in a cellular phone terminal as a portable electronic device according to an embodiment of the present invention.

A printed circuit board 2 is mounted inside a portable electronic device enclosed by a casing 1, and a pair of charging electrodes 3 exposed to the exterior is provided to the casing 1, as shown in FIG. 1. A pair of charging terminals, i.e., a charging terminal (positive electrode) 4a and a charging terminal (negative electrode, or ground) 4b are mounted upright on the printed circuit board 2, and the charging terminal (positive electrode) 4a and the charging terminal (negative electrode, or ground) 4b are connected to the pair of charging electrodes 3. The charging terminal (positive electrode) 4a and the charging terminal (negative electrode, or ground) 4b are electrically connected to a charging unit (not depicted) via the charging electrodes 3 by contact with the metal portion of the charging electrodes 3 that are exposed on the exterior of casing 1. The charging terminal (negative electrode, or ground) 4b is connected to the ground of the printed circuit board 2. Moreover, a high-frequency current suppression part 5 is mounted on the charging terminal (negative electrode, or ground) 4b via a serial connection. A hollow tube-shaped ferrite core is used as the high-frequency current suppression part 5, for example. The ferrite core has eddy current loss in the high frequency range. The present embodiment is an example in which the high-frequency current suppression part 5 is mounted on an existing terminal, and shows the most basic mounting embodiment. In the present embodiment, the high-frequency current suppression part 5 is serially connected to the charging terminal (negative electrode, or ground) 4b, which is itself connected to the ground of the printed circuit board 2.

A part having a resistance value deemed equivalent to a case of connecting a metal wire having high electrical conductivity in relation to direct current may be used as the high-frequency current suppression part 5, and the part is not required to have a particularly high resistance value. This is because the present invention suppresses the electrical current oscillation of the printed circuit board ground by deterring the high-frequency current component, and differs from prior art in which a purpose is to reduce an antenna current by setting the impedance high. Here, examples of metals having excellent conductivity include copper and aluminum. Gold plating, which has a high resistance to corrosion, can be used in connection portions; copper, a copper alloy, copper plating, or the like can be used in the wiring portions; and common electrode materials can be used. Specifically, sufficient effect can be achieved when the part is one having an impedance in which the real part Rₚ is 0.1 (Ω) or greater at high frequencies of 100 MHz or higher, and in which the real part Rₚ is Z or less, where Z is the magnitude of the characteristic impedance of the printed circuit board 2. The imaginary part of the impedance of the high-frequency current suppression part 5 is not required to be large. The impedance that causes the loss of high-frequency current can be set so that the real part Rₚ is 0.1 (Ω) or greater at high frequencies of 100 MHz or higher, and the imaginary part Xₚ is (Z²−Rₚ²)^{0.5} or less, where Z is the magnitude of the characteristic impedance of the printed circuit board 2.

Next, a high-frequency current that may be generated in the ground of the printed circuit board via a secondary electrostatic discharge will be described. FIG. 5 is a schematic view describing a secondary discharge of an electrostatic discharge or an electrification charge. A charging terminal (negative electrode, or ground) 4b is connected to the ground 8 of the printed circuit board, as shown in FIG. 5. When an electrostatic discharge 7 occurs from a source outside the device, there is the possibility that a secondary electrostatic discharge 12 will occur from the printed circuit board ground 8 via the charging terminal (negative electrode, or ground) 4b. Alternatively, when an electrification charge 13 accumulates at the ground 8 of the printed circuit board under the influence of static electricity from the exterior, there is the possibility that a secondary electrostatic discharge 12 will occur via the charging terminal (negative electrode, or ground) 4b. It is assumed here that an electric conductor 11 for the secondary discharge, which receives the secondary electrostatic discharge 12, is an electric conductor provided with some type of grounding 10 relative to the earth, or is an electric conductor that has a grounded floating capacitance 9. The grounding 10 is presumed to be sufficient for moving the charge or electrification charge 13 as a secondary electrostatic discharge 12 injected by the electrostatic discharge 7, or it is assumed that there is sufficient floating capacitance 9 to absorb the moving charge that accompanies the secondary charge. In this case, an electrostatic discharge 12 occurs and a steep discharge current containing many high-frequency components flows. At this time, oscillations produced by the high-frequency current are generated in the ground 8 of the printed circuit board. In view of the above, the high-frequency current generated from the secondary electrostatic discharge is suppressed by mounting a high-frequency current suppression part 5 in the discharge pathway, and deviation of the electric potential generated at the ground 8 of the printed circuit board can be reduced. The high-frequency current suppression part 5 is mounted on the charging terminal (negative electrode, or ground) 4b in FIG. 5. It can be envisioned that office desks, bookcases and other metal furniture, as well as automobiles, large appliances, and the like may be used as the electric conductor 11 for secondary discharge having a grounding 10 or floating capacitance 9.

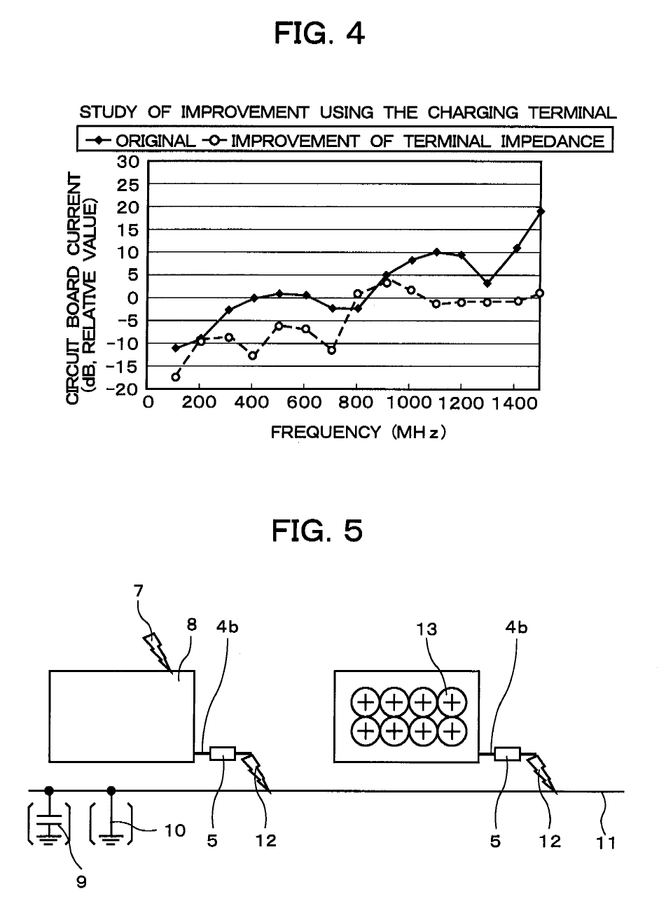

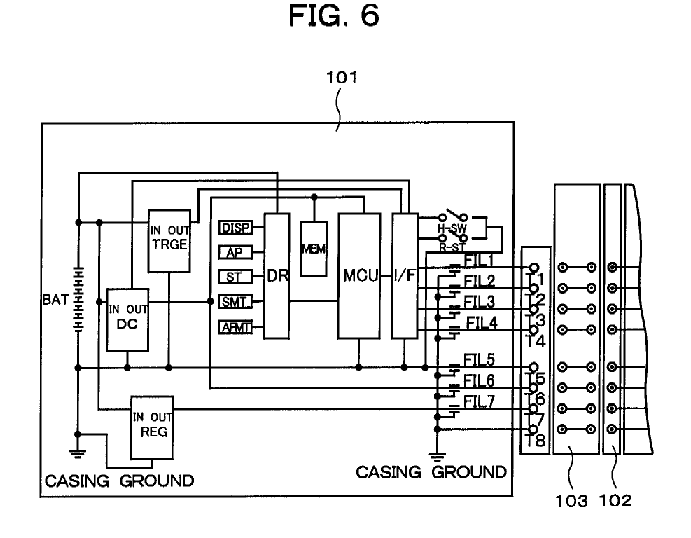

Next, results will be described from numerical simulations that were performed in order to confirm the effectiveness of the present embodiment and to investigate the resistance properties required in a high-frequency current suppression part. As a model of a portable communications terminal operating in the high-frequency band, a case was used in which static electricity was applied to a single point at the edge of a printed circuit board, a secondary discharge (removal of electricity) was induced via a charging terminal position set on the printed circuit board, and the electric current distribution on the printed circuit board was calculated in an electromagnetic field simulation. FIG. 4 is a graph showing the maximum value of a current distribution on such a printed circuit board at each frequency. In other words, the line designated “Original” in FIG. 4 corresponds to this type of current distribution, and has oscillatory waveforms having peaks in the neighborhood of 500 MHz and 1100 MHz. On the other hand, the line designated “Terminal Impedance Improvement” is a calculation example for the case in which a 0.1 (Ω) resistance is imparted to the charging terminal position. It is apparent that the oscillations observed when resistance is not present are reduced, and the overall electric current value is reduced at the same time. It is also apparent from the numeric calculation examples that a current having high-frequency noise can be sufficiently suppressed by mounting an part having a very small resistance value of about 0.1 (Ω) at the charging terminal portion where secondary electrical discharges occur.

Next, a modified example of the embodiments of the present invention will be described. FIGS. 2 and 3 show the first and second modified examples of the embodiments of the present invention, and the modifications are implemented on the printed circuit board. In FIGS. 2 and 3, the same reference numerals are used for the same constituent parts as those in FIG. 1, and a detailed description thereof is omitted. In FIG. 2, a lead part 14 that is a wired electronic part is used as the high-frequency current suppression part, and this lead part 14 is serially inserted in the charging terminal (negative electrode, or ground) 4b. In other words, since the lead part 14 is serially inserted in the charging terminal (negative electrode, or ground) 4b, a portion of the grounding is wired using the wiring pattern 16, and the lead part 14 is connected to a disconnected portion. On the other hand, in FIG. 3, a surface-mounted chip part 15 that has no lead is used as the high-frequency current suppression part. In other words, the chip part 15 is mounted on the wiring pattern 16 that is connected to the charging terminal (negative electrode, or ground) 4b. In this manner, the structure of the present invention can be implemented by serially disposing the high-frequency current suppression part in any location on the wiring that extends from the ground on the printed circuit board 2 to the charging terminal mounted upright on the ground. However, greater effectiveness can be obtained by disposing the part in a location nearer to the charging electrodes 3 shown in FIG. 1. The high-frequency current suppression part used in this case is, e.g., a ferrite core, chip beads, a toroidal core, or the like, and any of these parts consume the electrical energy of the high-frequency current as a heat loss. Examples of the shape of the part include one in which a single wire passed is passed through a hollow toroidal (doughnut) shape, one having a wiring wrapped thereabout (see FIG. 2), one in which a wire is passed through a fired ferrite material, or one in which any of these shapes are used as a chip part.

Fundamental configurations of the present invention are shown in FIGS. 1 through 3, but a greater effect can be achieved by combining the above examples and serially connecting a plurality of high-frequency current suppression parts.

In the present embodiment, the charging terminal (negative electrode, or ground) 4b is configured so as to be exposed to the exterior of the casing 1 via the charging electrodes 3, but the electrically conductive portion that is exposed to the exterior is not limited to the charging terminal and may be a metallic or metal-plated design part or the like used in the vicinity of an earphone jack or a hinge. The electrically conductive portion need not be exposed to the exterior, but may be applied to a metal part, a metal portion, a metal plating, an electrically conductive plating, an electrically conductive coating, or to any location that is connected to ground in which a creepage distance (the spatial distance along the insulation material where an insulation breakdown occurs) required for a secondary discharge is provided through a gap or the like in a seam of the casing.

### INDUSTRIAL APPLICABILITY

The present invention can be used advantageously to prevent malfunctions in portable electronic devices and other electronic circuits brought about by electrostatic discharges.

1. A portable electronic device comprising:
a printed circuit board;
a casing for housing the printed circuit board; and
an electrically conductive portion that is connected to a ground of said printed circuit board and in which a portion thereof is exposed on the exterior of said casing,
wherein a high-frequency current suppression part having loss due to eddy current in relation to direct current is serially disposed between said electrically conductive portion and said ground, excluding said electrically conductive portion as a terminal used in data transmission.

2. A portable electronic device comprising:
a printed circuit board;
a casing for housing the printed circuit board; and
an electrically conductive portion that is connected to a ground of said printed circuit board and in which a portion thereof is exposed on the exterior of said casing,
wherein a high-frequency current suppression part having a resistance value deemed equivalent to a case of connecting a metal wire having high electrical conductivity in relation to direct current is serially disposed between said electrically conductive portion and said ground, excluding said electrically conductive portion as a terminal used in data transmission.

3. The portable electronic device according to claim 2, wherein said high-frequency current suppression part has an impedance in which the real part Rₚ is 0.1 (Ω) or greater in relation to frequencies of 100 MHz or higher, and in which the real part Rₚ is Z or less, where Z is the magnitude of the characteristic impedance of said printed circuit board.

4. The portable electronic device according to claim 2, wherein said high-frequency current suppression part has an impedance in which the real part Rₚ is 0.1 (Ω) or greater in relation to frequencies of 100 MHz or higher, and the imaginary part Xₚ is (Z²−Rₚ²)^{0.5} or less, where Z is the magnitude of the characteristic impedance of said printed circuit board.

5. The portable electronic device according to claim 1, wherein said electrically conductive portion is a charging terminal.

6. The portable electronic device according to claim 2, wherein said electrically conductive portion is a charging terminal.
